(19) United States
(12) Patent Application Publication
(10) Pub. No.: US 2010/0025381 A1
(43) Pub. Date: Feb. 4, 2010

(54) METHOD FOR ARC JOINING

(76) Inventor: Thomas AMMANN, Munich (DE)

Correspondence Address: The BOC Group, Inc., 575 MOUNTAIN AVENUE, MURRAY HILL, NJ, 07974-2082, US

(21) Appl. No.: 12/356,871

(22) Filed: Jan. 21, 2009

(30) Foreign Application Priority Data
Jan. 29, 2008 (DE) 102008006557.9

(51) Int. Cl. B23K 9/16

(52) U.S. Cl. 219/74

(57) ABSTRACT

A method for arc joining, in particular for M[etal]S[hielding]G[as] welding and/or for M[etal]S[hielding]G[as] soldering of at least one object made of titanium and/or of at least a titanium alloy under shielding gas in the presence of at least one melting electrode, wherein at least an inert gas is supplied as shielding gas in such a manner that the arc burns in a stable and calm manner in response to the arc joining. The shielding gas further includes at least one active gas.

### CROSS REFERENCE TO RELATED APPLICATION

This application claims priority under 35 USC §119 to German Patent Application 102008006557.9 filed in the German Patent and Trademark Office on Jan. 29, 2008.

### BACKGROUND OF THE INVENTION

The instant invention relates to a method for arc joining of titanium or titanium alloy under a shielding gas having at least one melting electrode wherein the shielding gas comprises an inert gas and an active gas.

Arc joining under shielding gas is a joining technology which is often used, which comprises in particular the arc welding and the arc soldering. One of the technologies of arc joining used in the metal-processing industry for joining titanium is the M[etal]S[hielding]G[as] joining, in particular the M[etal]S[hielding]G[as] welding and/or the M[etal]S[hielding]G[as] soldering; see for example documents
“Wired for sound results . . . pulsed MIG welding of titanium” published by The Welding Institute (TWI) in TWI Bulletin January 2006, pages 8 to 12 and
“Gas Metal Arc Pulse Robotic Welding of s Titanium Ballistic Hull for the US Army Composite Armored Vehicle Integrated Hybrid Structure Program” by Matthew Hummers and Stephen Luckowski on the occasion of FABTECH International & AWS Welding Show 2003, Chicago, USA.

The T[ungsten]I[nert]G[as] joining is the preferred method for joining, in particular for welding and/or for soldering titanium.

A shielding gas, which in addition to the inert basis of argon or helium also contains small quantities of active gases, for example oxygen (O₂) or carbon dioxide (CO₂), is typically used for the MSG joining of the most different materials. The inert gas, for example a noble gas (mixture) of argon and/or of helium protects the liquid metal under the arc from oxidation. Among other things, the active gas portion ensures a high arc stability, a good penetration and a low surface tension of the melt.

Linde A G, for example, offers a shielding gas mixture of argon comprising 0.03 percent by volume (vol. %) of oxygen under the brand name VARIGON S for the metal-shielding gas-welding (MSG welding) of aluminum alloys (see, for example the document “Leistung durch Innovation und Kompe-tenz. Die Linde Schweiβschutzgase.”, published by Linde A G, order number 43385260 0805-1.5 Au).

The doping of the inert argon comprising a small portion of an active component stabilizes the arc, which has a positive effect on the welding result and which in particular leads to an improved seam appearance, a more even seam flaking and a smaller ejection of spillings.

Furthermore, Linde A G offers a protective gas mixture of argon comprising 30 vol. % of helium and comprising 0.03 vol. % of oxygen under the brand name VARIGON He30S for the MSG welding of aluminum alloys (see, for example, the document “Leistung durch Innovation und Kompetenz Die Linde Schweiβschutzgase.”, published by Linde A G, order number 43385260 0805-1.5 Au). The helium portion makes the arc hotter, wider and stiffer, which simplifies in particular the MSG welding of thick-thin connections, for example of a sheet comprising a thickness of approximately three millimeters on a sheet comprising a thickness of approximately eight millimeters.

In the state of the art from document EP 0 639 423 A1, it is furthermore known to supply a shielding gas mixture of argon and/or of helium comprising a portion of from 0.01 percent by volume (vol. %) to 0.7 vol. % of oxygen or carbon dioxide in response to the shielding gas arc welding of aluminum materials and of aluminum alloys.

Linde A G offers a shielding gas mixture of argon comprising 30 vol. % of helium comprising 2 vol. % of hydrogen and comprising 0.05 vol. % of carbon dioxide under the brand name CRONIGON Ni10 for the M[etal]S[hielding]G[as] welding of corrosion-stable steel (see document EP 0 639 427 A1 from the state of the art), for example of nickel-based materials (see, for example, the document “Leistung durch Innovation und Kompetenz. Die Linde Schweiβschutzgase.”, published by Linde A G, order number 43385260 0805-1.5 Au). The helium portion leads to an improved flow behavior as well as to an improved seam appearance, while the corrosion resistance of the material remains protected due to the portion of carbon dioxide, which is considerably reduced as compared to typical shielding gases for rust-resistant steel.

In the state of the art from document EP 0 544 187 A1, it is furthermore known to supply a shielding gas doped with carbon dioxide and/or with oxygen for the purpose of shielding gas-arc-welding of corrosion-resistant steel, in particular of nickel materials.

In the joining process, however, titanium is considered to be very sensitive as compared to active gas components such as oxygen, nitrogen or hydrogen. For this reason, only inert gases are conventionally suggested for the joining of titanium (see, for example, the document EP 1 815 937 A1 from the state of the art). The German Standard DIN EN 439, which lists shielding gases for arc welding and cutting, also demands titanium for a particular purity.

According to the state of the art, the joining of titanium is thus carried out by means of the method of the metal-inert gas joining, thus the metal-shielding gas-joining, with inert gases such as argon, helium or argon-helium mixtures. Due to the lack of active components in the shielding gas, however, the arc is highly unstable in response to the joining of titanium. Furthermore, this distinct arc unrest is intensified by a low stability of the free end of the joining electrode at an increased temperature, thus by an uncontrolled motion of the free end of the joining wire.

To attain improvements in the material transition as well as in the other welding characteristics in response to metal-inert gas joining, the document EP 1 277 539 B1 from the state of the art proposes to enrich the surface of this titanium auxiliary wire with oxygen in response to the use of a melting electrode made of titanium, for example a titanium welding wire. However, this requires the provision of a separate oxygen supply to the melting electrode, which is extensive and thus expensive.

### SUMMARY OF THE INVENTION

Based on the afore-described disadvantages and deficiencies as well as in appreciation of the outlined state of the art, the instant invention is based on the object of developing a method of the afore-mentioned type in such a manner that the arc burns in a stable and calm manner in response to the arc joining.

This object is solved by means of a method for arc joining, in particular for M[etal]S[hielding]G[as] welding and/or for M[etal]S[hielding]G[as] soldering of at least one object made of titanium and/or of at least a titanium alloy under shielding gas comprising at least one melting electrode, wherein at least an inert gas is supplied as shielding gas, characterized in that the shielding gas furthermore encompasses at least an active gas.

The present invention further relates to the use of a shielding gas for arc joining, in particular for M[etal]S[hielding]G[as] welding and/or for M[etal]S[hielding]G[as] soldering of at least one object made of titanium and/or of at least a titanium alloy under shielding gas comprising at least an active gas, in particular oxygen (O₂) and/or carbon dioxide (CO₂) and/or nitrogen (N₂), for example nitrogen monoxide (NO) or nitrous oxide (N₂O) and/or hydrogen (H₂) in a range of from approximately 0.005 percent by volume (vol. %) to approximately 0.2 vol. %, preferably in a range of from approximately 0.02 vol. % to approximately 0.06 vol. %, more preferably 0.028 vol. % to approximately 0.035 vol. % and in particular in a range of approximately 0.03 vol. % and at least an inert gas, in particular argon (Ar) and/or helium (He) in the remaining volume range.

### DETAILED DESCRIPTION OF THE INVENTION

Regardless of the prejudice existing according to the state of the art of the distinct sensitivity of titanium as compared to non-inert gas components, the instant invention proposes to supply at least an inert gas comprising an active portion or at least an inert gas mixture comprising an active portion for the arc joining of titanium. For example, the active portion can be a doping of oxygen (O₂) and/or of carbon dioxide (CO₂) and/or of hydrogen (H₂) and/or of nitrogen (N₂), for example nitrogen monoxide (NO) or of nitrous oxide (N₂O). Argon (Ar) and/or helium (He), for example, can be supplied as inert gas.

The instant invention is therefore based on supplying shielding gas comprising an active portion in response to the arc joining, in particular in response to the M[etal]S[hielding]G[as] welding of titanium even though the known distinct sensitivity of titanium as compared to non-inert gas components does not necessarily seem to recommend the use of such a gas.

Surprisingly, however, it was shown that the supply of the shielding gas mixture of inert gas and of active gas in response to the arc joining of titanium and/or of titanium alloys does not lead to an embrittlement of the joined region due to oxygen uptake. A deterioration of the expected mechanical characteristics of the region to be joined due to the active gas portion in the shielding gas can thus not be observed. On the contrary, an improvement of the arc stability can clearly be seen.

For example, the following internal laboratory test was carried out: the base material titanium having an efficiency rating of 2 according to the classification of the American Society for Testing and Materials (ASTM) and the material number 3.7035, respectively, was welded while supplying an oxygen-doped inert gas, that is, argon and 0.03 vol. % (corresponding to 300 parts per million and 300 ppm, respectively) of oxygen. In response to the welding, similar filler material, namely titanium grade 2 (3.7035) was supplied. The welding was carried out completely mechanized, that is, by guiding the burner by means of a longitudinal carriage comprising a Quinto pulsed current source from Carl Cloos Schweiβtechnik GmbH. The object to be welded had a sheet thickness of ten millimeters. M[etal]S[hielding]G[as] welding as well as T[ungsten]I[nert]G[as] welding was used as welding method.

Conventional welding samples, namely an MIG welding as well as a TIG welding, in each case with pure argon, were made for comparison purposes. The shielding gas sold under the name Argon 4.8 by Linde A G was used for this purpose. This shielding gas argon 4.8 has a purity degree of 99.998 percent and has maximally 3 ppm of oxygen (O₂), 10 ppm of nitrogen (N₂) and 5 ppm of moisture (H₂O) as minor components.

The mechanical characteristics, such as tensile strength and impact work were tested in the test laboratory. As compared to MIG welding with argon 4.8, the mechanical quality values when welding with argon and 0.03 vol. % of oxygen are even considerably better. The instant invention thus proves to be particularly advantageous when the arc joining is carried out by means of the method of the tungsten-inert gas joining (TIG joining), in particular the TIG welding and/or the TIG soldering.

According to an advantageous embodiment of the instant invention, the supplied shielding gas encompasses inert gas comprising an active gas portion in a range of from approximately 0.005 percent by volume (vol. %) (50 vpm) to approximately 0.2 vol. % (2000 vpm), preferably in a range of from approximately 0.02 vol. % (200 vpm) to approximately 0.06 vol. % (600 vpm), more preferably in a range of from approximately 0.028 vol. % (280 vpm) to approximately 0.035 vol. % (350 vpm) and in particular in a range of approximately 0.03 vol. % (300 vpm).

The inert gas portion of the shielding gas can encompass, for example, pure argon or argon comprising a helium portion of from approximately 10 percent by volume (vol. %) to approximately 60 vol. %, preferably of from approximately 25 vol. % to approximately 50 vol. %, more preferably of from 35 vol. % to approximately 30 vol. % and in particular of approximately 30 vol. %. When adding helium, it must be noted that the portion is chosen in such a manner that the arc-stabilizing effect of the doping completely remains. The addition of helium thus has an advantageous effect in particular with thicker sheets, for example when constructing pressure vessels and reactor.

In the afore-described internal laboratory test, the supplied shielding gas consisted of oxygen (O₂) in a range of approximately 0.03 vol. % and of argon (Ar) in the remaining volume range.

According to a further advantageous embodiment of the instant invention, the supplied shielding gas can encompass, for example,
oxygen (O₂) in a range of approximately 0.03 vol. %,
helium (He) in a range of approximately 30 vol. % and
argon (Ar) in the remaining volume range.

Furthermore, the shielding gas can encompass, for example,
carbon dioxide (CO₂) in a range of approximately 0.05 vol. % (500 vpm),
helium (He) in a range of approximately 50 vol. % and
argon (Ar) in the remaining volume range.

It was shown that very good results are shown in response to a doping with CO₂ in the afore-mentioned ranges and in particular in response to a doping with 300 vpm. However, in response to a doping with CO₂ it was furthermore shown that a doping with 500 vpm is particularly advisable in response to an addition of high helium portions in the rage of 50 vol. % (50±5 vol. %) so that a gas mixture of 500 vpm CO₂, 50 vol. % of He and argon for the remainder is particularly advantageous.

Finally, the instant invention relates to the use of at least a shielding gas comprising
at least an active gas, in particular oxygen (O₂) and/or carbon dioxide (CO₂) and/or nitrogen (N₂), for example nitrogen monoxide (NO) or nitrous oxide (N₂O) and/or hydrogen (H₂) in a range of from approximately 0.005 percent by volume (vol. %) (50 vpm) to approximately 0.2 vol. % (2000 vpm), in particular in a range of from approximately 0.02 vol. % (200 vpm) to approximately 0.06 vol. % (600 vpm), preferably 0.028 vol. % (280 vpm) to approximately 0.035 vol. % (350 vpm), in particular in a range of approximately 0.03 vol. % (300 vpm) and
at least an inert gas, in particular argon (Ar) and/or helium (He) in the remaining volume range,
   for arc joining, in particular for M[etal]S[hielding]G[as]welding and/or for M[etal]S[hielding]G[as] soldering of at least one object made of titanium and/or of at least a titanium alloy under shielding gas comprising at least one melting electrode.

1. A method for arc joining of at least one object made of titanium and/or of at least a titanium alloy under shielding gas comprising at least one melting electrode, wherein at least an inert gas is supplied as shielding gas, characterized in that the shielding gas further comprises at least an active gas.

2. The method according to claim 1, characterized in that the arc joining is selected from the group consisting of metal gas welding and metal gas soldering.

3. The method according to claim 1, characterized in that the inert gas is selected from the group consisting of argon and helium.

4. The method according to claim 1, characterized in that the active gas is selected from the group consisting of oxygen, carbon dioxide and nitrogen.

5. The method according to claim 1, characterized in that said active gas is selected from the group consisting of nitrogen monoxide, nitrous oxide and hydrogen.

6. The method according to claim 1, characterized in that the shielding gas comprises an active gas ranging from about 0.005 percent by volume to approximately 0.2 percent by volume, and the remainder is inert gas.

7. The method according to claim 1, characterized in that the shielding gas comprises an active gas ranging from about 0.02 percent by volume to approximately 0.06 percent by volume, and the remainder is inert gas.

8. The method according to claim 1, characterized in that the shielding gas comprises an active gas ranging from about 0.028 percent by volume to approximately 0.035 percent by volume, and the remainder is inert gas.

9. The method according to claim 1, characterized in that the shielding gas comprises an active gas 0.03 percent by volume and the remainder is inert gas.

10. The method according to claim 1, characterized in that said shielding gas comprises from about 10 percent by volume to about 60 percent by volume helium and the remainder being argon.

11. The method according to claim 1, characterized in that said shielding gas comprises about 20 percent by volume to about 50 percent by volume helium and the remainder being argon.

12. The method according to claim 1, characterized in that said shielding gas comprises about 25 percent by volume to about 30 percent by volume helium and the remainder being argon.

13. The method according to claim 1, characterized in that said shielding gas is about 30 percent by volume helium and the remainder being argon.

14. The method according to claim 1, characterized in that said shielding gas comprises about 0.03 percent by volume oxygen and the remainder being argon.

15. The method according to claim 1, characterized in that said shielding gas comprises about 0.3 percent by volume oxygen, about 30 percent helium and the remainder being argon.

16. The method according to claim 1, characterized in that said shielding gas comprises about 0.05 percent by volume carbon dioxide, about 50 percent by volume helium and the remainder being argon.

17. The method according to claim 1, characterized in that said arc joining is tungsten-inert gas joining.

18. The method according to claim 17, characterized in that said tungsten-inert gas joining is selected from the group consisting of tungsten-inert gas welding and tungsten-inert gas soldering.
